(19) United States
(12) Patent Application Publication
(10) Pub. No.: US 2026/0261132 A1
(43) Pub. Date: Sep. 3, 2026

(54) Method and Control Apparatus for Controlling Energy Exchanges Between a Plurality of Energy Systems via an Electrical Grid

(71) Applicant: Siemens Aktiengesellschaft, München (DE)

(72) Inventors: Sebastian Schreck, Nürnberg (DE); Arvid Amthor, Grabfeld OT Nordheim (DE); Thomas Schütz, Fürth (DE); Robin Sudhoff, Essen (DE)

(73) Assignee: Siemens Aktiengesellschaft, München (DE)

(21) Appl. No.: 18/993,076

(22) PCT Filed: Jul. 4, 2023
(86) PCT No.: PCT/EP2023/068305

§ 371 Date: Jan. 10, 2025

(30) Foreign Application Priority Data
Jul. 12, 2022 (EP) 22184329.5

(51) Int. Cl. H02J 3/46; G05B 13/04; H02J 101/24

(52) U.S. Cl. CPC H02J 3/46; G05B 13/042; H02J 2101/24

(57) ABSTRACT

Various embodiments of the teachings herein include a method for controlling energy exchanges between a plurality of energy systems via an electricity grid using a central control apparatus. An example includes: transmitting a respective value for a maximum amount of energy from each of the energy systems available for a defined time range to the central control apparatus; using a target function and the values transmitted from the plurality of energy systems to ascertain powers associated with the energy exchanges within a defined time range using an optimization method, wherein at least one of the energy systems comprises an installation that can be curtailed with respect to its power; transmitting a curtailment factor for the at least one curtailable energy system to the control apparatus; ascertaining the energy exchanges, using a condition represented by: αE_{i*;max}≤Σ_{t∈T}P_{i*;t}Δtₜ≤E_{i*;max}; and controlling the energy exchanges within the time range according to the ascertained powers.

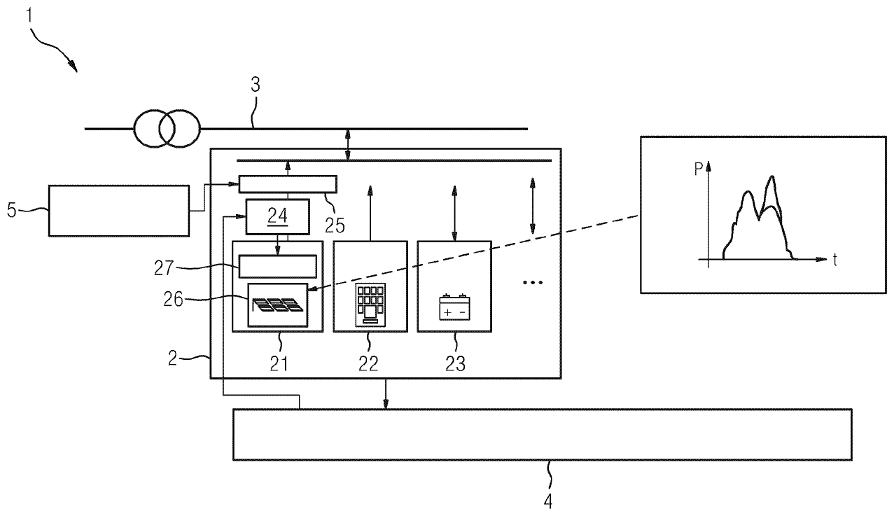

### CROSS-REFERENCE TO RELATED APPLICATIONS

This application is a U.S. National Stage Application of International Application No. PCT/EP2023/068305 filed Jul. 4, 2023, which designates the United States of America, and claims priority to EP Application Serial No. 22184329.5 filed Jul. 12, 2012, the contents of which are hereby incorporated by reference in their entirety.

### TECHNICAL FIELD

The present disclosure relates to electrical exchanges. Various embodiments of the teachings herein include systems and/or methods for controlling energy exchange between a plurality of energy systems via an electrical grid.

### BACKGROUND

Energy systems, for example districts, municipalities, buildings, industrial installations and the like, typically comprise different power installations, for example generation, consumption and/or storage installations. The most efficient possible allocation of the energy generated and consumed in the overall system and the energy exchange via an associated distribution grid (electricity grid) is a technical challenge which can be solved, for example, by means of a local energy market.

Such a local energy market platform for electricity grids is known for example from document EP 3518369 A1. Said document describes using existing flexibilities, for example by means of energy stores. This can reduce generation peaks and/or load peaks, with the result that increased loading of the associated electricity grid can be lessened or prevented.

Furthermore, controllable installations, in particular photovoltaic installations, could provide additional flexibility for the electricity grid. However, according to the prior art, this remains unused since, until now, the maximum infeed power of the installations has been curtailed in a sweeping manner and independently of the electricity grid. In order to prevent generation peaks, for example, the infeed power of photovoltaic installations is limited in a sweeping and permanent manner to 70 percent of the rated installation power.

### SUMMARY

The teachings of the present disclosure include systems and/or methods which may better utilize flexibilities present within an electricity grid. For example, some embodiments of the teachings herein include a method for controlling energy exchanges between a plurality of energy systems i (2) via an electricity grid (3) by means of a central control apparatus (4), wherein the control apparatus (4) comprises an optimization module which is designed, on the basis of a target function and data transmitted by the energy systems i (2), to ascertain the powers P_{i;t} associated with the energy exchanges within a defined time range T=UₜΔtₜ by means of an optimization method, wherein at least one of the energy systems i* (2) comprises an installation (21) that can be curtailed with respect to its power, including: each of the energy systems i (2) transmitting a maximum amount of energy E_{i;max} for the defined time range T to the control apparatus (4); the associated energy system i* (2) transmitting a curtailment factor α for the curtailable system (21) to the control apparatus (4); the optimization module ascertaining the energy exchanges, wherein the secondary condition

$$α {E}_{{i}^{*} ; max} \leq {\sum }_{t ∈ T} {P}_{{i}^{*} ; t} Δ {t}_{t} \leq {E}_{{i}^{*} ; max}$$

is used in the optimization method; and controlling the energy exchanges within the time range T according to the ascertained powers P_{i;t}.

In some embodiments, the curtailment factor α has a value in the range of from 0 to 1.

In some embodiments, each of the energy systems i (2) transmits a maximum power P_{i;max} to the control apparatus (4), wherein the additional secondary conditions P_{i;t}≤P_{i;max} are used in the optimization method.

In some embodiments, the powers P_{i;t} ascertained by means of the optimization method are transmitted to a respective control unit (24) of the respective energy systems i (2) in order to control the energy exchanges.

In some embodiments, the curtailable installation (21) is in the form of a photovoltaic installation (26) having a controllable inverter (27).

In some embodiments, the curtailment factor α has a value of 0.7.

In some embodiments, within the time range T, energy systems j (2) feeding into the electricity grid (3) transmit a weighting factor

$${g}_{j ; min ; t}^{i n}$$

and energy systems k (2) feeding out of the electrical grid (3) transmit a weighting factor

$${g}_{k ; max ; t}^{o u t}$$

to the control apparatus (4), wherein the target function comprises at least the term

$${\sum }_{j \neq k ; t ∈ T} [ {P}_{j ; t}^{i n} {g}_{j ; t}^{i n} - {P}_{k ; t}^{o u t} {g}_{k ; t}^{out} ] , wherein {P}_{j ; t}^{i n}$$

denotes a power infeed of the associated energy system j (2) into the electricity grid (3) and

$${P}_{i ; t}^{o u t}$$

denotes a power output of the associated energy system i (2) out of the electricity grid (3), wherein the powers

$${P}_{j ; t}^{i n} , {P}_{j ; t}^{o u t}$$

provided for the control, and the weightings

$${g}_{j ; t}^{i n} , {g}_{k ; t}^{o u t}$$

are ascertained by the optimization method using the additional secondary conditions

$${g}_{j ; min ; t}^{i n} \leq {g}_{j ; t}^{i n} and {g}_{k ; t}^{o u t} \leq {g}_{k ; max ; t}^{o u t} .$$

In some embodiments, the time range T is a day.

In some embodiments, the time range T is divided into periodic time steps Δtₜ=Δt.

As another example, some embodiments include a control apparatus (4) for controlling energy exchanges between a plurality of energy systems i (2) via an electricity grid (3), wherein the control apparatus (4) comprises an optimization module which is designed, on the basis of a target function and data transmitted by the energy systems i (2), to ascertain the powers P_{i;t} associated with the energy exchanges within a defined time range T=UₜΔtₜ by means of an optimization method, wherein at least one of the energy systems i* (2) comprises a installation (21) that can be curtailed with respect to its power, characterized in that the control apparatus (4) is designed: to receive a maximum amount of energy E_{i;max} from each of the energy systems i (2) for the defined time range T; to receive from the associated energy system i* (2) a curtailment factor α for the curtailable system (21); to ascertain the energy exchanges by way of the optimization module, wherein the optimization module is designed to use the secondary condition

$$α {E}_{{i}^{*} ; max} \leq {\sum }_{t ∈ T} {P}_{{i}^{*} ; t} Δ {t}_{t} \leq {E}_{{i}^{*} ; max}$$

in the optimization method; and to control the energy exchanges within the time range T according to the ascertained powers P_{i;t}.

### BRIEF DESCRIPTION OF THE DRAWINGS

Further advantages, features, and details of the teachings of the present disclosure are apparent from the exemplary embodiments described below and with reference to the drawing. The FIGURE in this case schematically shows an example control apparatus incorporating teachings of the present disclosure. Identical, equivalent or functionally identical elements may be provided with the same reference signs in the FIGURE.

### DETAILED DESCRIPTION

An example method for controlling energy exchanges between a plurality of energy systems i via an electricity grid by means of a central control apparatus, wherein the control apparatus comprises an optimization module which is designed, on the basis of a target function and data transmitted by the energy systems i, to ascertain the powers P_{i;t} associated with the energy exchanges within a defined time range T=UₜΔtₜ by means of an optimization method, wherein at least one of the energy systems i* comprises a installation that can be curtailed with respect to its power, includes: each of the energy systems i transmitting a maximum amount of energy E_{i;max} for the defined time range T to the control apparatus; the associated energy system i* transmitting a curtailment factor α for the curtailable system to the control apparatus; the optimization module ascertaining the energy exchanges, wherein the secondary condition

$$α {E}_{{i}^{*} ; max} \leq {\sum }_{t ∈ T} {P}_{{i}^{*} ; t} Δ {t}_{t} \leq {E}_{{i}^{*} ; max}$$

is used in the optimization method; and controlling the energy exchanges within the time range T according to the ascertained powers P_{i;t}.

The methods described herein and/or one or more functions, features, and/or steps of the methods and/or of one of its configurations can be computer-aided. By way of example, the optimization module is in the form of a software module, wherein the optimization method is carried out numerically.

From a structural viewpoint, the IPCC Fifth Assessment Report in particular defines an energy system as: “All components related to the generation, conversion, delivery and use of energy” (Annex I, page 1261).

Energy systems typically comprise a plurality of components, in particular energy installations, for example energy conversion installations, consumption installations and/or storage installations. In this case, energy systems can generate and/or provide a plurality of forms of energy (multimodal energy systems). In particular, an energy system of this type provides one or more forms of energy for a consumer, for example a building, an industrial installation or private installations, wherein the provision is effected in particular by means of a conversion of various forms of energy, by means of a transportation of various forms of energy and/or by means of stored forms of energy. In other words, the various forms of energy, for example heat, cold or electrical energy, are coupled by means of the multimodal energy system in terms of their generation, their provision and/or their storage. Energy systems are for example buildings, in particular residential buildings and/or office buildings, and/or industrial installations.

The energy system can comprise one or more of the following components as energy installation: Electricity generators, cogeneration plants, in particular combined heat and power plants, gas boilers, diesel generators, heat pumps, compression refrigeration machines, absorption refrigeration machines, pumps, district heating networks, energy transfer lines, wind farms or wind turbines, photovoltaic installations, energy storage devices, in particular battery storage devices, biomass installations, biogas installations, waste incineration plants, industrial installations, conventional power plants and/or the like.

The present method may include a plurality of energy systems, for example buildings, which exchange energy via an electricity grid. In this case, the energy systems can feed power into and/or output power from the electricity grid. As a result of a power fed into and/or fed out of the electricity grid for a specific time range, a specific energy or amount of energy exchanged between the energy systems is formed, that is to say energy is exchanged between the energy systems.

The energy exchanges between the energy systems are controlled or regulated by means of the control apparatus that is central with respect to the energy systems. In this case, the control is carried out by means of the optimization module of the control apparatus, which optimization module is designed to carry out an optimization method. An optimization method in the context of the present disclosure includes a numerical method in which setpoint values for the powers on which the energy exchanges are based are ascertained. In this case, the powers or power values mentioned are variables of a defined target function which is minimized or maximized within the scope of the optimization method. In other words, the minimum or maximum of the target function defines the powers or their setpoint values for the control. In this case, the target function typically models a technical target which is tracked for the energy exchanges, for example the best possible correspondence between generation and consumption, the lowest possible carbon dioxide emission or the greatest possible energy conversion.

The optimization or the optimization method takes place over the defined time range T, which is divided into smaller time steps or time intervals Δtₜ. For example, the time range T is one day and Δtₜ is one hour and/or one quarter of an hour.

A power P_{i;t} is associated with an energy exchange within the time range Δtₜ. In other words, the powers which are ascertained by means of the optimization method are constant within the smaller time ranges Δtₜ. In principle, the powers are thus time-dependent over the time range T.

In some embodiments, at least one of the energy systems comprises a curtailable installation. In this case, the power of the installation can be curtailed, that is to say reduced, in a temporally variable manner. Curtailable installations may be independent of whether an infeed or output is present, photovoltaic installations, wind power installation, heat pumps, refrigeration machines, charging processes for electric vehicles and/or the like.

In some embodiments, each of the energy systems transmits a maximum amount of energy E_{i;max} for the defined time range T to the control apparatus. For example, for discrete time steps, E_{i;max}=Σ_{t∈T}P_{i;max;t}Δtₜ with P_{i;max;t} is the maximum power per time step. Thus, the transmission of the maximum powers P_{i;max;t} for each time step is equivalent to the transmission of the maximum amount of energy. According to the invention, the transmission of the maximum power P_{i;max;t} to the control apparatus is thus likewise provided. As a result, the control apparatus is thus aware of which energy system can or would like to feed in and/or output what maximum amount of energy and/or what maximum possibly time-dependent power.

In some embodiments, the energy system comprising the curtailable installation transmits a curtailment factor to the control apparatus. If a plurality of energy systems comprises one or more curtailable installations, then each of these energy systems can transmit an associated curtailment factor to the control apparatus for each of its installations. As a result, the control apparatus is aware of how far the power of the curtailable installation can be restricted. The curtailment factor can be defined by the energy system, by the manufacturer, by a grid operator of the electricity grid and/or by the legislator.

In some embodiments, the powers provided for the control or the setpoint powers are ascertained by way of the optimization method. In this case, the optimization method is based on the data transmitted by the energy systems. The secondary condition

$$α {E}_{{i}^{*} ; max} \leq {\sum }_{t ∈ T} {P}_{{i}^{*} ; t} Δ {t}_{t} \leq {E}_{{i}^{*} ; max}$$

is used or taken into account in the optimization. The secondary condition thus requires the transmitted data. The secondary condition used has the technical effect that the actual curtailment factor used for the control is not fixed but dynamically has a value in the range of from α to 1. In other words, an effective curtailment factor is formed by Δ_{eff}=Σ_{t∈T}P_{i*;t}Δtₜ/E_{i*;max} for the installation in association with the determined power P_{i*;t}. The installation is thus not curtailed in a sweeping manner using the defined curtailment factor α, but rather its flexibility is utilized. The dynamic curtailment factor actually used is thus optimally ascertained in accordance with the target function. A sweeping or predefined curtailment of the installation according to α is thus not effected according to the invention.

In some embodiments, the energy exchanges or power exchanges are controlled within the time range T in accordance with the ascertained powers P_{i;t}. In this case, the control is typically carried out indirectly by way of the control apparatus. The control apparatus has ascertained setpoint values for the powers of each energy system by means of the optimization carried out. These setpoint values are then transmitted to the respective energy systems. Within the energy systems, the setpoint values of the powers are converted by control units and/or regulating units which transmit corresponding control signals to the respective installations.

In contrast to a sweeping curtailment, the power or the curtailment is ascertained with regard to whether curtailment is technically expedient, for example on account of grid boundary conditions of the electricity grid. Thus, there is no curtailment per se, but only if it is technically advantageous. As a result of the information about existing flexibilities or controllable/curtailable loads, these can be shifted by the optimization in such a way that a curtailment is not required. Thus, renewable energies do not have to be curtailed in a sweeping manner with no technical reason.

Furthermore, as a result, a grid operator of the electricity grid has the option to dynamically set the curtailment factor depending on the load on the electricity grid. As a result, unfounded curtailment, for example as a result of the static 70 percent rule, can be avoided in grid sections which are hardly affected by excessive generation. This reduces compensation payments for unfounded curtailment, and possible CO₂ emissions for replacing the curtailed generation at another location and at another time in the grid area by conventional power stations.

An example control apparatus incorporating teachings of the present disclosure for controlling energy exchanges between a plurality of energy systems i via an electricity grid, wherein the control apparatus comprises an optimization module which is designed, on the basis of a target function and data transmitted by the energy systems i, to ascertain the powers P_{i;t} associated with the energy exchanges within a defined time range T=UₜΔtₜ by means of an optimization method, wherein at least one of the energy systems i* comprises an installation that can be curtailed with respect to its power, is designed: to receive a maximum amount of energy E_{i;max} from each of the energy systems i for the defined time range T; to receive from the associated energy system i* a curtailment factor α for the curtailable system; to ascertain the energy exchanges by way of the optimization module, wherein the optimization module is designed to use the secondary condition

$$α {E}_{{i}^{*} ; max} \leq {\sum }_{t ∈ T} {P}_{{i}^{*} ; t} Δ {t}_{t} \leq {E}_{{i}^{*} ; max}$$

in the optimization method; and to control the energy exchanges within the time range T according to the ascertained powers P_{i;t}.

The result is advantages and/or configurations of the control apparatus that are similar to, equivalent to and have the same effect as those of the methods described herein.

In some embodiments, the curtailment factor α has a value in the range of from 0 to 1, in particular in the range of from 0.7 to 1. The curtailment factor α forms a maximum curtailment factor, since this or the effective curtailment factor actually used for the control is made dynamic by the secondary condition αE_{i*;max}≤Σ_{t∈T}P_{i*;t}Δtₜ≤E_{i*;max}. The curtailment factor α thus indicates the power up to which the installation can or must be curtailed to the maximum extent, such that a value in the range between 0 and 1 is technically expedient. For photovoltaic installations, α has a value of 70 percent (0.7), for example.

In some embodiments, each of the energy systems i transmits a maximum power P_{i;max;t} to the control apparatus, wherein the additional secondary conditions P_{i;t}≤P_{i;max;t} are used in the optimization method.

As a result, the result of the optimization, the setpoint powers, the maximum power of the respective energy system or of its installations are respected at each point in time. The installations or the energy systems are thus loaded at most up to their transmitted maximum power. Additional secondary conditions can be provided, that is to say can be used in the optimization, to achieve technical objectives, for example grid boundary conditions.

In some embodiments, the powers P_{i;t} (setpoint values or setpoint powers) ascertained by means of the optimization method are transmitted to a respective control unit of the respective energy system i for controlling the energy exchanges. As a result, the setpoint values ascertained by the control apparatus are converted locally, that is to say the energy exchanges between the energy systems are controlled in accordance with the ascertained setpoint powers.

In some embodiments, the curtailable installation is in the form of a photovoltaic installation having a controllable inverter. Photovoltaic installations are typically limited to an infeed power of 70 percent of their maximum possible infeed power by means of their associated inverter. This is no longer necessary, or the aforementioned rigid and sweeping curtailment is dispensed with. Depending on the grid requirement, the infeed is based on a dynamic curtailment factor in the range of 70 percent and 100 percent.

In some embodiments, the transferred curtailment factor for photovoltaic installations has a value of 70 percent or 0.7. The secondary condition used is thus 0.7·E_{i*;max}≤Σ_{t∈T}P_{i*;t}Δtₜ≤E_{i*;max}. This is equivalent to a dynamic curtailment factor in the range of from 0.7 to 1.

In some embodiments, within the time range T, energy systems j feeding into the electricity grid transmit a weighting factor

$${g}_{j ; min ; t}^{i n}$$

and energy system k feeding out of the electrical grid transmit a weighting factor

$${g}_{k ; max ; t}^{out}$$

to the control apparatus, wherein the target function of the optimization problem comprises at least the term

$${\sum }_{j \neq k ; t ∈ T} [ {P}_{j ; t}^{in} {g}_{j ; t}^{in} - {P}_{k ; t}^{out} {g}_{k ; t}^{out} ] , wherein {P}_{j ; t}^{in}$$

denotes a power infeed of the associated energy system j into the electricity grid and

$${P}_{i ; t}^{out}$$

denotes a power output of the associated energy system i out of the electricity grid, wherein the powers

$${P}_{j ; t}^{in} , {P}_{k ; t}^{out}$$

provided for the control and the weightings

$${g}_{j ; t}^{in} , {g}_{k ; t}^{out}$$

are ascertained by the optimization method using the additional secondary conditions

$${g}_{j ; min ; t}^{in} \leq {g}_{j ; t}^{in} and {g}_{k ; t}^{out} \leq {g}_{k ; max ; t}^{out} .$$

It is thus possible to distinguish between energy systems feeding into the electricity grid and energy systems feeding out of the electricity grid. This is done through the different weighting factors and their different inputs (weighting and sign) into the target function used. The weightings can characterize in particular carbon dioxide emissions, such that a minimum of the converted carbon dioxide volume is achieved by minimizing the target function. Furthermore, the target function used enables the best possible match between generation and consumption, which can also be weighted differently. The stated target function is advantageous in particular if the control apparatus forms a local energy market platform.

In some embodiments, the time range T is a day. As a result, the most efficient possible energy exchanges for a coming day, in particular for the next day, can be ascertained in the sense of the optimization.

In some embodiments, the time range T is divided into regular time steps Δtₜ=Δt. As a result, the optimization method becomes more efficient and can be carried out in a shorter computing time. Furthermore, grid control units provided for the control of electricity grids typically have a temporally regular resolution, for example in accordance with 15-minute time intervals. As a result, the present method can be adapted to the temporal resolution of the grid control unit of the electricity grid.

The FIGURE shows a control apparatus 4, which is central with respect to a plurality of energy systems 2, for controlling energy exchanges between a plurality of energy systems 2 via an electricity grid 3 according to one configuration of the present invention. For reasons of clarity, only one of the energy systems 2 is illustrated in the FIGURE.

The control apparatus 4 is embedded in a system 1 which comprises at least the plurality of energy systems 2, the electricity grid 3 and a grid control unit 5 for controlling the electricity grid 3.

The illustrated energy system 2 comprises a curtailable installation 21, one or more consumers 22 and one or more energy storage devices 23, in particular battery storage devices.

The curtailable installation 21 comprises an inverter 26 and a photovoltaic installation 27. By means of the inverter 26, the power of the photovoltaic installation 27 can be set at least between its maximum power (peak power) and a minimum power set by a curtailment factor α. α typically has the value 0.7.

For the basic control/regulation of the curtailable installation 21, the energy system 2 has a local control unit 24.

Furthermore, the energy system 2 comprises a communication module 25 for data exchange with the central control apparatus 4. The energy system can thus transmit data/information to the control apparatus 4 by means of the communication module 25. This is indicated in the FIGURE by an arrow from the energy system 2 to the control apparatus 4.

Furthermore, the control apparatus 4 can transmit data, in particular setpoint power values, to the energy system 2 and/or directly to the local control unit 24 via the communication module 25. This is indicated by an arrow from the control apparatus 4 to the control unit 24.

The communication module 25 can also exchange data with the grid control unit 5. In particular, the grid control unit 5 can transmit data relating to the control of the installations 21, 22, 23 or of the energy system 2, for example grid boundary conditions, to the communication module 25 and thus to the energy system 2. This is indicated by an arrow from the grid control unit 5 to the communication module 25.

The control apparatus 4 is designed to ascertain setpoint values for the time-dependent powers within a defined time range, for example for a day, on the basis of data transmitted from the energy systems 2. For this purpose, the control apparatus 4 has an optimization module. In this instance, the control apparatus 4 may be in the form of a local energy market platform. The ascertained setpoint powers are subsequently transmitted directly or indirectly, for example via the communication module 5, to the local control units 24 in order to carry out the corresponding energy exchanges via the electricity grid 3. The local control units 24 then carry out the energy exchanges in accordance with the ascertained and transmitted setpoint powers, that is to say the control units 24 pass on corresponding control signals to the installations 21, 22, 23.

The illustrated energy system 2 comprises the curtailable installation 21. A maximum amount of energy and/or a maximum time-dependent power and a curtailment factor for the installation 21 are transmitted to the control apparatus 4, for example by means of the communication module 25.

On the basis of the transmitted maximum amount of energy E_{i*;max} or maximum time-dependent power P_{i;t;max;t} (time-dependent maximum power) and the transmitted curtailment factor, the control apparatus 4 ascertains, by means of its optimization module, at least the setpoint power for the installation 21. The secondary condition E_{t*;max}≤E_{t∈T}P_{i*;t}Δtₜ≤E_{i*;max} is taken into account in this case. The secondary condition technically leads to an effective, dynamic curtailment factor. In this case, P_{i;t} is the optimization variable for the installation 21 and its value that is determined by the optimization method corresponds to the setpoint power of the installation 21. The ascertained setpoint power is transmitted to the energy system 2. The installation 21 is thus controlled in accordance with the determined setpoint power P_{i*;t}.

As a result, the installation 21 is not rigidly curtailed to a fixed power, but its flexibility with respect to its power is used in a way that serves the grid.

Although the teachings herein have been described and illustrated in more detail by way of the exemplary embodiments, the disclosure is not restricted by the disclosed examples, or other variations may be derived therefrom by a person skilled in the art without departing from the scope of protection thereof.

### LIST OF REFERENCE SIGNS

1 System
2 Energy system
3 Electricity grid
4 Central control apparatus
5 Grid control unit
21 Curtailable installation
22 Consumer
23 Energy storage device
24 Control unit
25 Communication module
26 Photovoltaic installation
27 Inverter

What is claimed is:

1. A method for controlling energy exchanges between a plurality of energy systems i via an electricity grid using a central control apparatus, the method comprising:
transmitting a respective value for a maximum amount of energy E_{i;max} from each of the energy systems available for a defined time range to the central control apparatus;
using a target function and the values transmitted from the plurality of energy systems to ascertain powers P_{i;t} associated with the energy exchanges within a defined time range T=UₜΔₜ, using an optimization method, wherein at least one of the energy systems i* comprises an installation that can be curtailed with respect to its power;
transmitting a curtailment factor α for the at least one curtailable energy system to the control apparatus;
ascertaining the energy exchanges, using a condition represented by:
$$α {E}_{{i}^{*} ; max} \leq {\sum }_{t ∈ T} {P}_{{i}^{*} ; t} Δ {t}_{t} \leq {E}_{{i}^{*} ; max}$$
and
controlling the energy exchanges within the time range according to the ascertained powers.

2. The method as claimed in claim 1, wherein the curtailment factor has a value in the range of from 0 to 1.

3. The method as claimed in claim 1, wherein additional secondary conditions P_{i;t}≤P_{i;max} are used in the optimization method.

4. The method as claimed in claim 1, further comprising transmitting the ascertained powers P_{i;t} to a respective control unit of the respective energy systems in order to control the energy exchanges.

5. The method as claimed in claim 1, wherein the curtailable installation comprises a photovoltaic installation with a controllable inverter.

6. The method as claimed in claim 5, wherein the curtailment factor α has a value of 0.7.

7. The method as claimed in claim 1, wherein, within the time range T, energy systems j (2) feeding into the electricity grid (3) transmit a weighting factor
$${g}_{j ; min ; t}^{in}$$
and energy systems k (2) feeding out of the electrical grid (3) transmit a weighting factor
$${g}_{k ; max ; t}^{out}$$
to the control apparatus (4), wherein the target function comprises at least the term
$${\sum }_{j \neq k ; t ∈ T} [ {P}_{j ; t}^{in} {g}_{j ; t}^{in} - {P}_{k ; t}^{out} {g}_{k ; t}^{out} ] , wherein {P}_{j ; t}^{in}$$
denotes a power infeed of the associated energy system j (2) into the electricity grid (3) and
$${P}_{i ; t}^{out}$$
denotes a power output of the associated energy system i (2) out of the electricity grid (3), wherein the powers
$${P}_{j ; t}^{in} , {P}_{j ; t}^{out}$$
provided for the control, and the weightings
$${g}_{j ; t}^{in} , {g}_{k ; t}^{out}$$
are ascertained by the optimization method using the additional secondary conditions
$${g}_{j ; min ; t}^{in} \leq {g}_{j ; t}^{in} and {g}_{k ; t}^{out} \leq {g}_{k ; max ; t}^{out} .$$

8. The method as claimed in claim 1, wherein the time range T is a day.

9. The method as claimed in claim 1, wherein the time range T is divided into periodic time steps Δtₜ=Δt.

10. A control apparatus for controlling energy exchanges between a plurality of energy systems i via an electricity grid, wherein the control apparatus comprising:
an optimization module programmed to use a target function and data transmitted from the energy systems i to ascertain powers P_{i;t} associated with the energy exchanges within a defined time range T=UₜΔtₜ using an optimization method,
wherein at least one of the energy systems i* comprises an installation that can be curtailed with respect to its power;
wherein the optimization module receives a value representing a maximum amount of energy E_{i;max} available from each of the energy systems i for the defined time range T;
receives a curtailment factor α for the curtailable system;
ascertains the energy exchanges secondary condition:
$$α {E}_{{i}^{*} ; max} \leq {\sum }_{t ∈ T} {P}_{{i}^{*} ; t} Δ {t}_{t} \leq {E}_{{i}^{*} ; max}$$
and
controls the energy exchanges within the time range T according to the ascertained powers P_{i;t}.
